(19) United States
(12) Patent Application Publication
(10) Pub. No.: US 2013/0040634 A1
(43) Pub. Date: Feb. 14, 2013

(54) Method and Apparatus for Managing Access to User Equipment Event Information

(71) Applicants: Per Johan Mikael Johansson, Kungsangen (SE); Lin-Yi Wu, New Taipei City (TW); Yih-Shen Chen, Hsinchu City (TW); Shiang-Jiun Lin, Hsinchu City (TW)

(72) Inventors: Per Johan Mikael Johansson, Kungsangen (SE); Lin-Yi Wu, New Taipei City (TW); Yih-Shen Chen, Hsinchu City (TW); Shiang-Jiun Lin, Hsinchu City (TW)

(73) Assignee: MEDIATEK, INC., Hsin-Chu (TW)

(21) Appl. No.: 13/570,578

(22) Filed: Aug. 9, 2012

Related U.S. Application Data
(60) Provisional application No. 61/522,039, filed on Aug. 10, 2011.

(51) Int. Cl. H04W 4/00

(52) U.S. Cl. 455/422.1

(57) ABSTRACT

A method of managing access to problem event information collected by a User Equipment (UE). In one novel aspect, access to the problem event information is determined by a public land mobile network (PLMN) list stored in the UE. The UE collects problem event information, stores a PLMN list, and sends an indication that problem event information is available to a Radio Access Network (RAN) controller. In response, the RAN controller sends a request indicator to the UE requesting the event information. The UE transmits the requested event information when the requesting PLMN is included in the PLMN list stored in the UE. In one embodiment, the event information includes Minimization Drive Test (MDT) measurement information. In another embodiment, the event information includes radio link failure information. The solution enables managing access to problem event information with maximum simplicity and minimum impact to existing systems.

### CROSS REFERENCE TO RELATED APPLICATIONS

This application claims priority under 35 U.S.C. §119 from U.S. Provisional Application No. 61/522,039, entitled “Equivalent PLMN Support for Minimization of Drive Test (MDT),” filed on Aug. 10, 2011, the subject matter of which is incorporated herein by reference.

### TECHNICAL FIELD

The disclosed embodiments of the present invention relate generally to wireless communication technology and, more particularly, relate to a method and apparatus for managing access to user equipment stored event information.

### BACKGROUND

The modern era of communications has brought about an enormous expansion of wireline and wireless networks. Computer networks, television networks, and telephony networks are experiencing an unprecedented technological expansion, fueled by consumer demands, while providing more flexibility and immediacy for information transfer.

Current and future networking technologies continue to facilitate ease of information transfer and convenience, telecommunication industry service providers are developing improvements to existing networks. For example, the evolved universal mobile telecommunications system (UMTS) terrestrial radio access network (E-UTRAN) is currently being developed. The E-UTRAN, which is also known as Long Term Evolution (LTE), is aimed at upgrading prior technologies by improving efficiency, lowering costs, improving services, making use of new spectrum opportunities, and providing better integration with other open standards.

One advantage of E-UTRAN which continues to be shared with other preceding telecommunication standards is the fact that users are enabled to access a network employing such standards while remaining mobile. Thus, for example, users having mobile terminals equipped to communicate in accordance with such standards may travel vast distances while maintaining communication with the network. By providing access to users while enabling user mobility, services are available to users while the users remain mobile. However, the mobility of users requires the network to provide continuity of service to the mobile users by enabling a user's mobile terminal to be handed over between different serving stations within corresponding different cells or service areas. To verify and test radio network deployment and operation, drive tests have been conducted in the past. Drive testing typically involved the use of specific measurement tools that could be driving through an area to collect data for network operation verification. Thus, manual testing and verification of radio network operation has been common.

For existing and especially for newer networks (e.g. LTE and future networks), it may be desirable to reduce the need for drive testing to reduce manual testing of networks and therefore reduce operational costs. Accordingly, studies regarding support for minimization of drive tests (MDT) are currently popular which aim to utilize commercial terminals for reporting of relevant measurement results in order to avoid separate manual testing with special test equipment and involvement of operator personnel.

Although the current invention is not limited to the context of MDT, MDT is deemed to be the closest current art. MDT feature enables UEs to perform Operations, Administration, and Maintenance (OAM) activities, such as neighborhood detection, measurements, logging and recording for OAM purposes, which includes radio resource management (RRM) and optimization purposes. There are two types of MDT. For immediate MDT, measurements are performed by the UEs in CONNECTED state. The collected information is available to be reported to the network immediately. For logged MDT, measurements are performed and logged by the UEs in IDLE state. The UEs may report the collected information to the network at a later point of time.

The UE collected measurement information (also referred to as event information) during MDT, in general, may contain location information of the user, or may contain data from which location of the user can be estimated. For example, RAN logs of immediate MDT, logs of logged MDT, and logs of problem events such as Radio Link Failure, may all contain location information or data from which location can be estimated. MDT thus creates a need for an efficient and automatic management scheme for governing how the event information collecting UE shares the collected event information with various networks. In the current art, such a management scheme does not exist.

It is the objective of the current invention to address the shortcomings in current art. It is desirable to provide a solution that fulfills the new system requirements related to managing access to event information, such as MDT measurement and Radio Link Failure, with maximum simplicity and minimum impact to the current system.

### SUMMARY

A method and apparatus for managing access to user equipment (UE) event information is provided. In one novel aspect, access event information is determined based upon a list of PLMN identifications stored in memory with the event information. The UE collects event information and stores the event information and a list of PLMN identifications in a storage device within the UE. The UE then determines whether or not to communicate the collected event information with a Radio Access Network (RAN) based upon the Registered PLMN and the list of PLMN identifications stored with the event information. The UE performs this determination by using one of two access management schemes: (i) event information access management with UE event information notification, or (ii) event information management without UE event information notification. Both access management schemes enable access management of event information with maximum simplicity and minimum impact to the current system.

In the event information access management with UE event information notification, the UE collects event information and stores the event information with a list of PLMN identifications, and determines if the presently registered PLMN of the UE is included in the list of PLMN identifications stored with the event information. If the presently registered PLMN is included in the list of PLMN identifications, then the UE sends an event information indicator indicating to the RAN that event information is available. In response to receiving the event information indicator, the RAN sends a request indicator to the UE and thereby requests the event information be communicated to a requesting device. Upon receiving the request indicator, the UE again checks if the presently registered PLMN identification is included in the list of PLMN identifications and only transmits the event information to the requesting device if the presently registered PLMN identification is included in the list of PLMN identifications.

In the event information access management without UE event information notification, the UE collects event information and stores the event information with a list of PLMN identifications. Then, at an independent moment in time, the RAN sends a request indicator to the UE and thereby requests that any available event information be communicated to a requesting device. Upon receiving the request indicator, the UE checks if the presently registered PLMN identification is included in the list of PLMN identifications (stored with the event information) and only transmits the event information to the requesting device if the presently registered PLMN identification is included in the list of PLMN identifications.

Other embodiments and advantages are described in the detailed description below. This summary does not purport to define the invention. The invention is defined by the claims.

### BRIEF DESCRIPTION OF THE DRAWINGS

FIG. 1 illustrates 3GPP system architecture in accordance with one novel aspect.

FIG. 2 illustrates a method and apparatus of managing event information access.

FIG. 3 illustrates a procedure for managing event information access in an E-UTRAN network in accordance with one novel aspect.

FIG. 4 illustrates a procedure for managing event information access in an E-UTRAN network in accordance with one novel aspect.

FIG. 5 illustrates a procedure for managing event information access in an UTRAN network in accordance with one novel aspect.

FIG. 6 illustrates a procedure for managing event information access in an UTRAN network in accordance with one novel aspect.

FIG. 7 is a flow chart of a method of managing event information access in accordance with one novel aspect.

FIG. 8 is a flow chart of a method of managing event information access in accordance with one novel aspect.

### DETAILED DESCRIPTION

Reference will now be made in detail to some embodiments of the invention, examples of which are illustrated in the accompanying drawings.

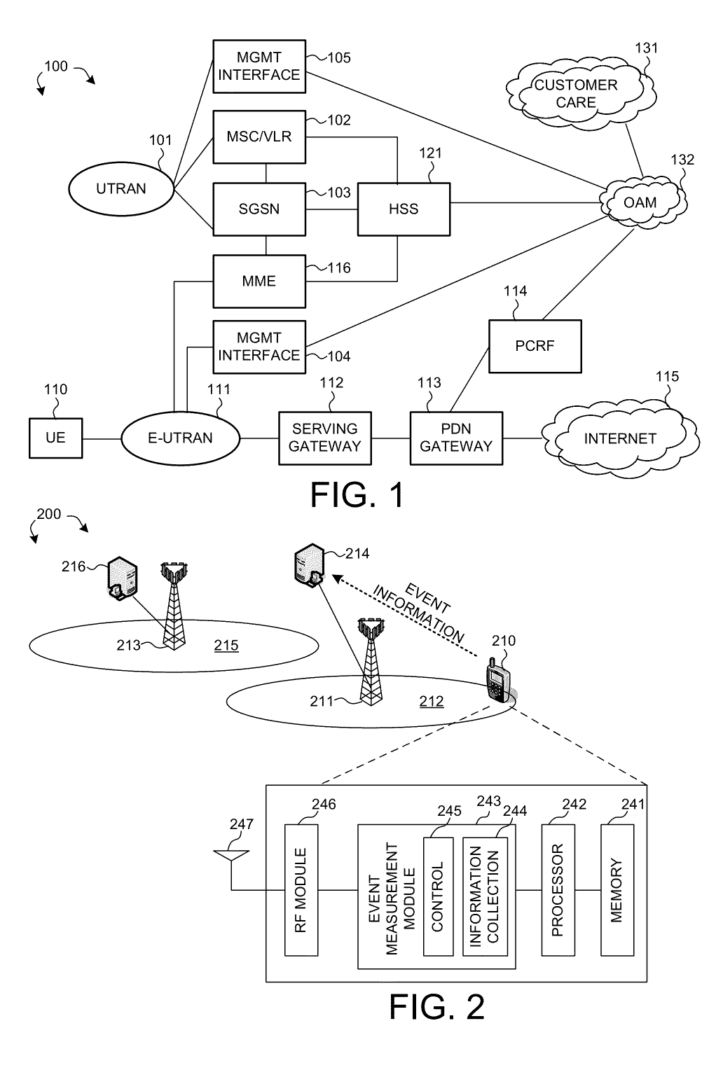

FIG. 1 illustrates a 3GPP system architecture in accordance with one novel aspect. 3GPP system 100 comprises an UTRAN radio access network 101, a Mobile Switching Centre or a visitor location register (MSC/VLR) 102, a serving GPRS (general packet radio service) support node (SGSN) 103, a user equipment UE 110, an E-UTRAN radio access network 111, a serving gateway S-GW 112, a packet data network (PDN) gateway PDN-GW 113, a policy control and routing function (PCRF) 114, operator's IP services (e.g., the Internet) 115, a home subscriber server (HSS) 121, a customer care center 131, and an Operation, Administration, and Maintenance (OAM) system 132. In the example of FIG. 1, E-UTRAN 111 provides a new air interface for cellular services to UE 110 via OFDMA (Orthogonal Frequency Division Multiple Access) technology. E-UTRAN 111 may also provide IP services to UE 110 through S-GW 112 and P-GW 113. On the other hand, UTRAN 101 is an UMTS radio access network that provides connectivity between UEs and the network via W-CDMA (Wideband Code Division Multiple Access) technology. In 3GPP LTE systems, HSS 121, S-GW 112, and PDN-GW 113, and other nodes (not shown) form an evolved packet core network, while the evolved packet core network and E-UTRAN 111 together form a public land mobile network (PLMN). In 3GPP UTRA systems, HSS 121, MSC 102, SGSN 103, and other nodes (not shown) form a core network. UTRAN 101 and the core network together form a public land mobile network (PLMN). While E-UTRAN and UTRAN radio access networks are described above, one skilled in the art will appreciated that other radio access networks may be improved by the present invention. A few of these radio access networks are High Speed Downlink Packet Access (HSDPA) network, a High Speed Uplink Packet Access (HSUPA) network, a Code Division Multiple Access (CDMA) network, Self Organizing Network (SON), or an Orthogonal Frequency Division Multiple Access (OFDMA) radio access network.

3GPP introduces new features to help LTE and UTRA system operators to further optimize network planning in a cost-effective way. Minimization of Drive Test (MDT) is one of the features where UEs collect measurements and report measurement information to their serving eNBs and serving RNCs. MDT feature enables UEs to perform Operations, Administration, and Maintenance (OAM) activities, such as neighborhood detection, measurements, logging and recording for OAM purposes, which includes radio resource management (RRM) and optimization purposes. There are two types of MDT. For immediate MDT, measurements are performed by the UEs in connected state. The collected information is available to be reported to the network immediately. For logged MDT, measurements are performed and logged by the UEs in IDLE state. The UEs may report the collected information to the network at a later point of time.

The UE collected measurement information (also referred to as event information), in general, may contain MDT measurement information, logs of broadcast communication failure information, logs of multicast communication failure information, logs of Random Access Channel (RACH) performance, and logs of communication problems including Radio Link Failure, Handover Failure, and Radio Resource Control (RRC) Connection Establishment Failure. For example, RAN logs of immediate MDT, logs of logged MDT, and logs of problem events such as Radio Link Failure, may all contain location and velocity information or data from which location and velocity can be estimated. MDT thus creates a need for an efficient and automatic management scheme for governing how the UE collecting event information shares the collected event information with various radio access networks. In the current art, such a management scheme does not exist.

In one novel aspect, access to event information is determined based upon a list of PLMN identifications stored in memory with the event information. The UE collects event information and stores the event information and a list of PLMN identifications in a storage device within the UE. The UE then determines whether or not to communicate the collected event information with a Radio Access Network (RAN) based upon a Registered PLMN identification and the list of PLMN identifications stored with the event information. The registered PLMN identification is the PLMN identification of the PLMN on which the UE has performed a location registration successfully. The UE performs this determination by using one of two access management schemes: (i) event information access management with UE event information notification, or (ii) event information management without UE event information notification. Both access management schemes enable access management of event information with maximum simplicity and minimum impact to the current system. A main benefit of using already stored information in the UE for the security procedures of determining whether to share event information with the network or not is realized when the recording and reporting of event information is non-configured (e.g. when all UEs always record information without prior configuration). The benefit is a significant reduction in signaling as otherwise all UEs would need signaling to understand when to share such information.

FIG. 2 illustrates an exemplary method and apparatus for collecting and accessing event information in a mobile network 200. Mobile network 200 comprises a UE 210, an EUTRAN cell 212, and a UTRAN cell 215. The E-UTRAN cell 212 has an eNodeB 211 and a Radio Access Network (RAN) control node 214. The UTRAN cell 215 has a NodeB 213 and a Radio Access Network (RAN) control node 216. Using 3GPP LTE system as an example, UE 210 subscribes cellular and IP services via E-UTRAN cell 212, and is served by the serving eNodeB 211. UE 210 comprises memory 241, a processor 242, an event measurement module 243 including an information collection module 244 (e.g., measures and records event information), a control module 245 (e.g., compares the registered PLMN identification with the list of PLMN identifications and determines if event information is transmitted to the RAN controller 214), and a radio frequency (RF) module 246 coupled to an antenna 247. The contents of UE 210 provide the ability for the UE to collect event information (information collection module 244) and store the event information and a list of PLMN identifications in memory 241 (a storage device) within the UE. The components of the UE 210 also provide the ability for the UE to determine whether (control module 245) to communicate (processor 242, RF module 246 and antenna 247) the collected event information with a Radio Access Network (RAN) based upon the registered PLMN and the list of PLMN identifications stored with the event information. The UE performs this determination by using one of two access management schemes: (i) event information access management with UE event information notification, or (ii) event information management without UE event information notification.

The different modules are function modules that may be implemented by software, firmware, hardware, or any combination thereof. The function modules, when executed by the processor, allow UE 210 to perform event information collection and reporting of event information to the RAN controller 214. Similarly, for 3GPP UTRA system, UTRAN cell 215 provides services to users.

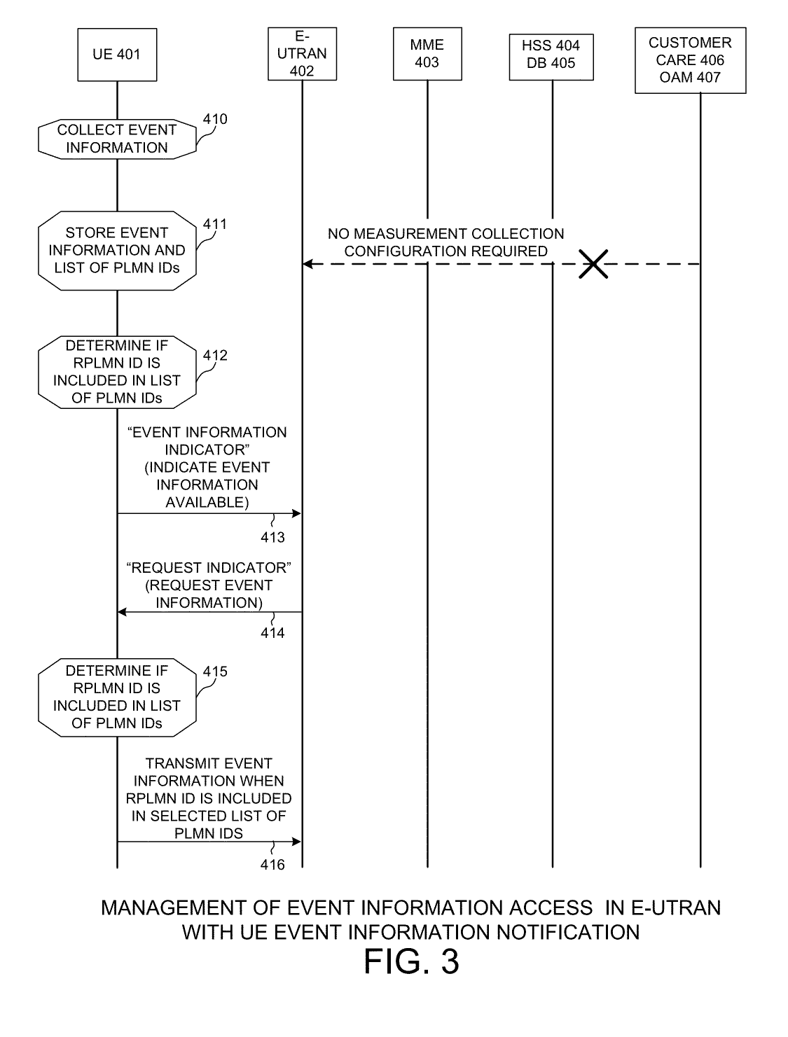

FIG. 3 illustrates a first embodiment of management of event information access in E-UTRAN with UE event information notification in one novel aspect. Mobile network 400 comprises a UE 401, an E-UTRAN 402, an MME 403, an HSS 404 having a central DB 405, a customer care system 406, and an OAM system 407. In step 410, UE 401 begins collecting event information. Event information can be any measurement related to network performance observed by the UE. For example, event information may include Minimization Drive Test (MDT) measurement information, broadcast communication failure information, multicast communication failure information, Random Access Channel (RACH) performance, and communication problems including Radio Link Failure, Handover Failure, and Radio Resource Control (RRC) Connection Establishment Failure. In one example, the UE collects information regarding multiple events and generates a log of event information.

The UE then stores the collected event information and an existing list of PLMN identifications (“reference list of PLMN identifications”) previously stored in the UE (Step 411). In one example, the stored list of PLMN identifications is either a list of equivalent PLMN (EPLMN) identifications or a list of equivalent home PLMN (EHPLMN) identifications. In another example, the UE has a PLMN type indicator value stored in memory that is used by the UE to determine whether the list of PLMN identifications stored with the collected event information is a list of EHPLMN identifications or a list of EPLMN identifications. In another example, the list of PLMN identifications stored with the event information is a list of Equivalent Home Public Land Mobile Networks (EHPLMN) identifications when the UE is not roaming.

In step 412 the UE then determines if the current registered PLMN identification (presently registered PLMN identification) is included in the list of PLMN identifications stored with the collected event information. If the registered PLMN identification is included in the stored list of PLMN identifications, then the UE sends an event information indicator to E-UTRAN 402 indicating that event information is available on UE 401 (Step 413). In one example, the event information indicator is a sequence of bits added to an unrelated message that is to be sent from the UE 401 to the E-UTRAN 402. In another example, the event information indicator is sent in a dedicated message from the UE 401 to the E-UTRAN 402.

E-UTRAN 402 then determines if access to the event information on UE 401 is desired. If E-UTRAN 402 desired access to the event information stored on UE 401, E-UTRAN 402 sends a request indicator to UE 401 requesting that the event information be communicated to a requesting device (Step 414). In one example, the requesting device is a radio access control node. Similar to the event information indicator, the request indicator may be a sequence of bits added to an unrelated message that is to be sent from the E-UTRAN 402 to the UE 401. In another example, the request indicator is sent in a dedicated message from E-UTRAN 402 to UE 401.

Upon receiving the request indicator, the UE 401 determines if the presently registered PLMN identification is included in the stored list of PLMN identifications (Step 415). In the event that the registered PLMN identification is included in the stored list of PLMN identifications, then the UE 401 communicates the event information to the requesting device (Step 416). In the event that the registered PLMN identification is not included in the stored list of PLMN identifications, then the UE 401 does not communicate the event information to any device. It is noted that during this entire process no measurement collection configuration is required. Rather, the UE 401 independently measures and collects event information that is later made available for access by the radio access network.

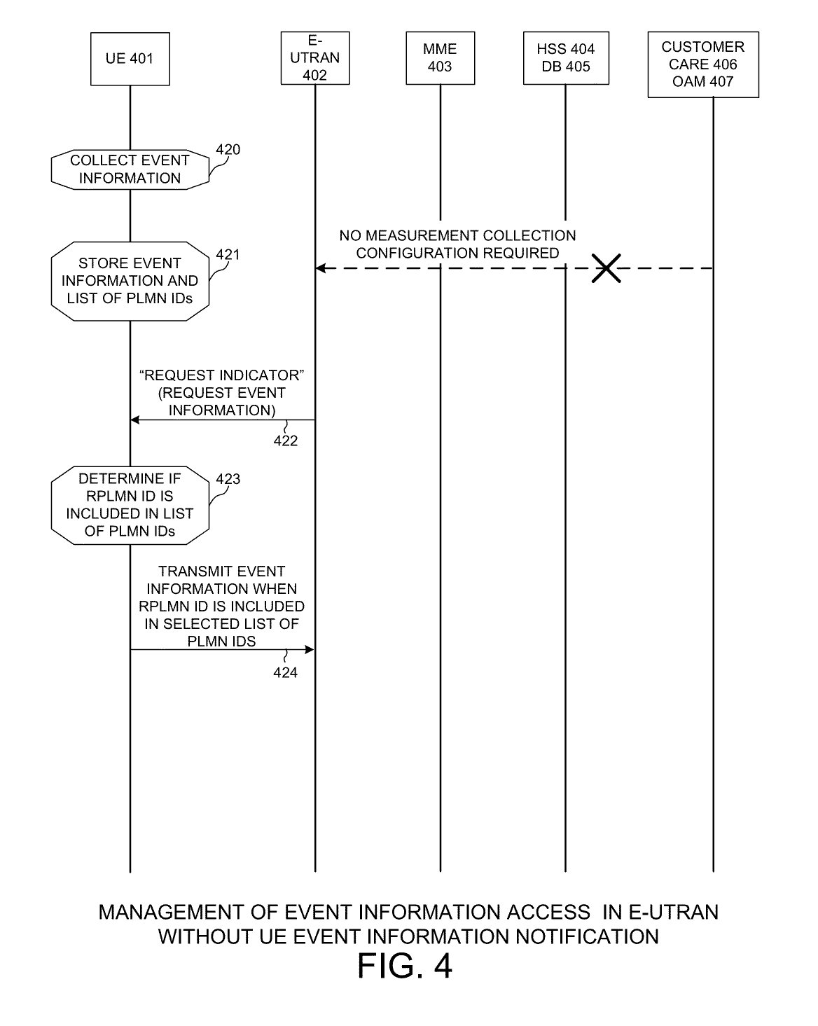

FIG. 4 illustrates a second embodiment of management of event information access in E-UTRAN without UE event information notification in accordance with one novel aspect. The mobile network 400 shown in FIG. 4 is the same mobile network shown in FIG. 3, however, FIG. 4 illustrates event information management without UE event information notification.

Mobile network 400 comprises a UE 401, an E-UTRAN 402, an MME 403, an HSS 404 having a central DB 405, a customer care system 406, and an OAM system 407. In step 420, UE 401 begins collecting event information. Event information can be any measurement related to network performance observed by the UE. For example, event information may include Minimization Drive Test (MDT) measurement information, broadcast communication failure information, multicast communication failure information, Random Access Channel (RACH) performance, and communication problems including Radio Link Failure, Handover Failure, and Radio Resource Control (RRC) Connection Establishment Failure. In one example, the UE collects information regarding multiple events and generates a log of event information.

The UE then stores the collected event information and an existing list of PLMN identifications (“reference list of PLMN identifications”) previously stored in the UE (Step 421). In one example, the stored list of PLMN identifications is either a list of equivalent PLMN (EPLMN) identifications or a list of equivalent home PLMN (EHPLMN) identifications. In another example, the UE has a PLMN type indicator value stored in memory that is used by the UE to determine whether the list of PLMN identifications stored with the collected event information is a list of EHPLMN identifications or a list of EPLMN identifications. In another example, the list of PLMN identifications stored with the event information is a list of Equivalent Home Public Land Mobile Networks (EHPLMN) identifications when the UE is not roaming. E-UTRAN 402 then determines if access to the event information on UE 401 is desired. If E-UTRAN 402 desired access to the event information stored on UE 401, E-UTRAN 402 sends a request indicator to UE 401 requesting that the event information be communicated to a requesting device (Step 422). At this point in time, the E-UTRAN 402 has not received an event information indicator from UE 401, but rather the E-UTRAN 402 is polling the UE 401 on the chance that UE 401 does have stored event information. In one example, the requesting device is a radio access control node. Similar to the event information indicator, the request indicator may be a sequence of bits added to an unrelated message that is to be sent from the E-UTRAN 402 to the UE 401. In another example, the request indicator is sent in a dedicated message from E-UTRAN 402 to UE 401.

Upon receiving the request indicator, the UE 401 determines if the presently registered PLMN identification is included in the stored list of PLMN identifications (Step 423). In the event that the registered PLMN identification is included in the stored list of PLMN identifications, then the UE 401 communicates the event information to the requesting device (Step 424). In the event that the registered PLMN identification is not included in the stored list of PLMN identifications, then the UE 401 does not communicate the event information to any device. It is noted that during this entire process no measurement collection configuration is required. Rather, the UE 401 independently measures and collects event information that is later made available for access by the radio access network.

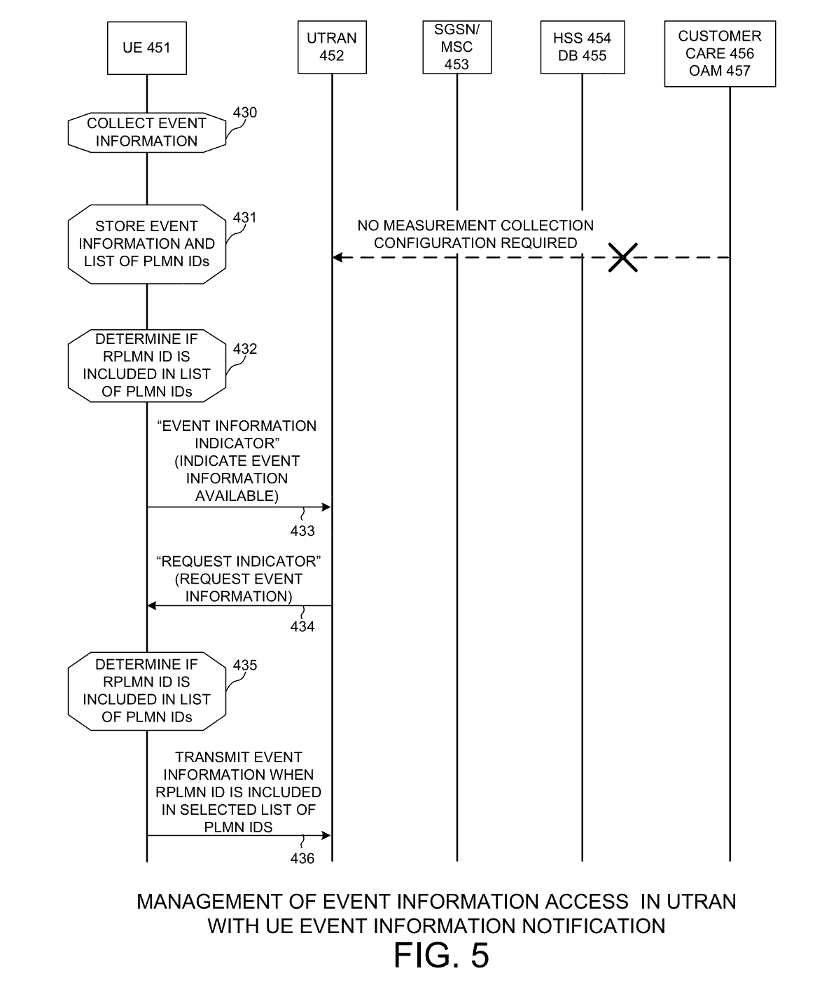

FIG. 5 illustrates a first embodiment of management of event information access in UTRAN with UE event information notification in one novel aspect. Mobile network 450 comprises a UE 451, an UTRAN 452, an SGSN/MCC 453, an HSS 454 having a central DB 455, a customer care system 456, and an OAM system 457. In step 430, UE 451 begins collecting event information. Event information can be any measurement related to network performance observed by the UE. For example, event information may include Minimization Drive Test (MDT) measurement information, broadcast communication failure information, multicast communication failure information, Random Access Channel (RACH) performance, and communication problems including Radio Link Failure, Handover Failure, and Radio Resource Control (RRC) Connection Establishment Failure. In one example, the UE collects information regarding multiple events and generates a log of event information.

The UE then stores the collected event information and an existing list of PLMN identifications (“reference list of PLMN identifications”) previously stored in the UE (Step 431). In one example, the stored list of PLMN identifications is either a list of equivalent PLMN (EPLMN) identifications or a list of equivalent home PLMN (EHPLMN) identifications. In another example, the UE has a PLMN type indicator value stored in memory that is used by the UE to determine whether the list of PLMN identifications stored with the collected event information is a list of EHPLMN identifications or a list of EPLMN identifications. In another example, the list of PLMN identifications stored with the event information is a list of Equivalent Home Public Land Mobile Networks (EHPLMN) identifications when the UE is not roaming.

In step 432 the UE then determines if the current registered PLMN identification (presently registered PLMN identification) is included in the list of PLMN identifications stored with the collected event information. If the registered PLMN identification is included in the stored list of PLMN identifications, then the UE sends an event information indicator to UTRAN 452 indicating that event information is available on UE 451 (Step 433). In one example, the event information indicator is a sequence of bits added to an unrelated message that is to be sent from the UE 451 to the UTRAN 452. In another example, the event information indicator is sent in a dedicated message from the UE 451 to the UTRAN 452.

UTRAN 452 then determines if access to the event information on UE 451 is desired. If UTRAN 452 desires access to the event information stored on UE 451, UTRAN 452 sends a request indicator to UE 451 requesting that the event information be communicated to a requesting device (Step 434). In one example, the requesting device is a radio access control node. Similar to the event information indicator, the request indicator may be a sequence of bits added to an unrelated message that is to be sent from the UTRAN 452 to the UE 451. In another example, the request indicator is sent in a dedicated message from UTRAN 452 to UE 451.

Upon receiving the request indicator, the UE 451 determines if the presently registered PLMN identification is included in the stored list of PLMN identifications (Step 435). In the event that the registered PLMN identification is included in the stored list of PLMN identifications, then the UE 451 communicates the event information to the requesting device (Step 436). In the event that the registered PLMN identification is not included in the stored list of PLMN identifications, then the UE 451 does not communicate the event information to any device. It is noted that during this entire process no measurement collection configuration is required. Rather, the UE 451 independently measures and collects event information that is later made available for access by the radio access network.

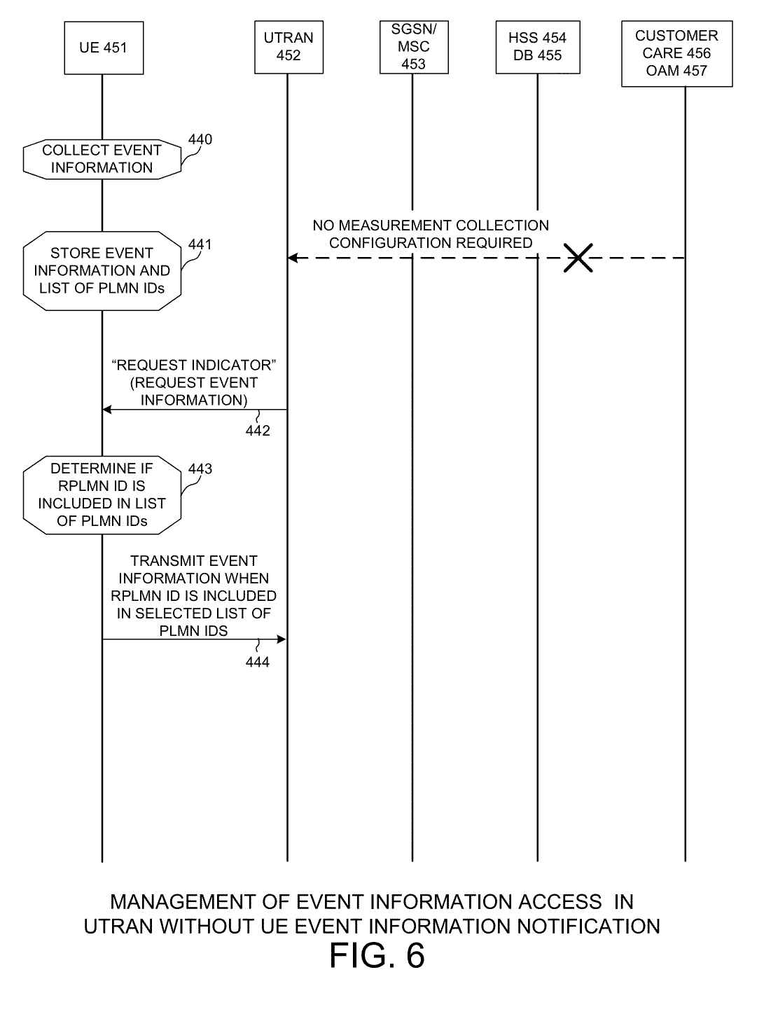

FIG. 6 illustrates a second embodiment of management of event information access in UTRAN without UE event information notification in accordance with one novel aspect. The mobile network 450 shown in FIG. 6 is the same mobile network shown in FIG. 5, however, FIG. 6 illustrates event information management without UE event information notification.

Mobile network 450 comprises a UE 451, an UTRAN 452, an MME 453, an HSS 454 having a central DB 455, a customer care system 456, and an OAM system 457. In step 440, UE 451 begins collecting event information. Event information can be any measurement related to network performance observed by the UE. For example, event information may include Minimization Drive Test (MDT) measurement information, broadcast communication failure information, multicast communication failure information, Random Access Channel (RACH) performance, and communication problems including Radio Link Failure, Handover Failure, and Radio Resource Control (RRC) Connection Establishment Failure. In one example, the UE collects information regarding multiple events and generates a log of event information.

The UE then stores the collected event information and an existing list of PLMN identifications (“reference list of PLMN identifications”) previously stored in the UE 451 (Step 441). In one example, the stored list of PLMN identifications is either a list of equivalent PLMN (EPLMN) identifications or a list of equivalent home PLMN (EHPLMN) identifications. In another example, the UE has a PLMN type indicator value stored in memory that is used by the UE to determine whether the list of PLMN identifications stored with the collected event information is a list of EHPLMN identifications or a list of EPLMN identifications. In another example, the list of PLMN identifications stored with the event information is a list of Equivalent Home Public Land Mobile Networks (EHPLMN) identifications when the UE is not roaming. UTRAN 452 then determines if access to the event information on UE 401 is desired. If UTRAN 452 desires access to the event information stored on UE 451, UTRAN 452 sends a request indicator to UE 451 requesting that the event information be communicated to a requesting device (Step 442). At this point in time, the UTRAN 452 has not received an event information indicator from UE 451, but rather the UTRAN 452 is polling the UE 451 on the chance that UE 451 does have stored event information. In one example, the requesting device is a radio access control node. The request indicator may be a sequence of bits added to an unrelated message that is to be sent from the UTRAN 452 to the UE 451. In another example, the request indicator is sent in a dedicated message from UTRAN 452 to UE 451.

Upon receiving the request indicator, the UE 451 determines if the presently registered PLMN identification is included in the stored list of PLMN identifications (Step 443). In the event that the registered PLMN identification is included in the stored list of PLMN identifications, then the UE 451 communicates the event information to the requesting device (Step 444). In the event that the registered PLMN identification is not included in the stored list of PLMN identifications, then the UE 451 does not communicate the event information to any device. It is noted that during this entire process no measurement collection configuration is required. Rather, the UE 451 independently measures and collects event information that is later made available for access by the radio access network.

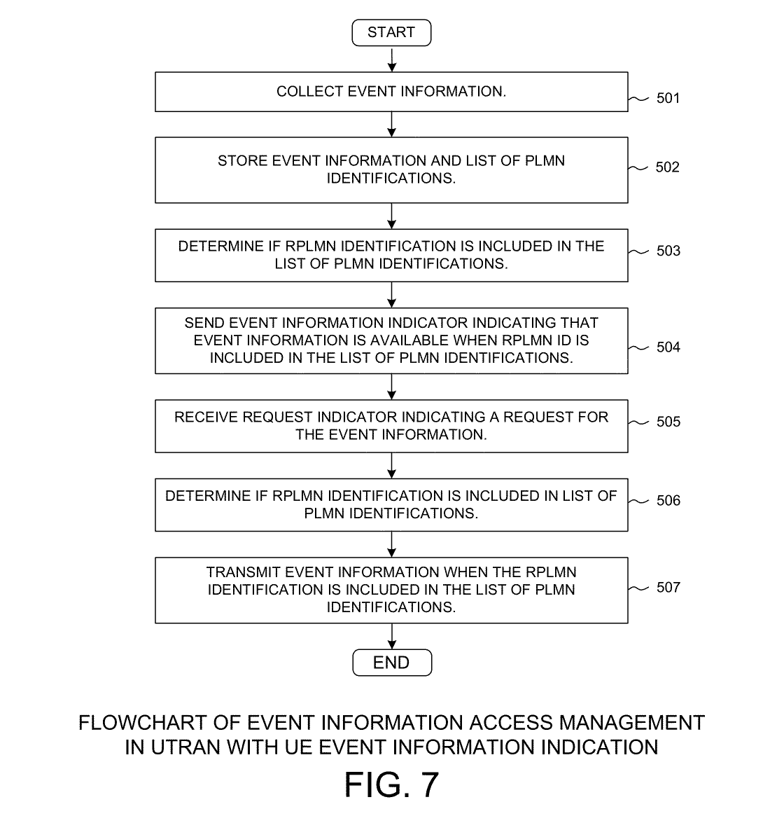

FIG. 7 is a flow chart of a method of management of event information access with UE event information notification in accordance with one novel aspect. The mobile network comprises a UE and a radio access network (RAN). In step 501, the UE begins measuring and collecting event information observed by the UE during operation. Upon acquiring event information, the UE then stores the collected event information and an existing list of PLMN identifications previously stored in the UE (Step 502). In one example, the stored list of PLMN identifications is either a list of equivalent PLMN (EPLMN) identifications or a list of equivalent home PLMN (EHPLMN) identifications. In another example, the UE has a PLMN type indicator value stored in memory that is used by the UE to determine whether the list of PLMN identifications stored with the collected event information is a list of EHPLMN identifications or a list of EPLMN identifications. In another example, the list of PLMN identifications stored with the event information is a list of Equivalent Home Public Land Mobile Networks (EHPLMN) identifications when the UE is not roaming.

In Step 503, the UE determines if the presently registered PLMN identification is included in the list of PLMN identifications stored with the event information. In the event that the presently registered PLMN identification is included in the list of PLMN identifications stored with the even information, the UE sends an event information indicator to the radio access network indicating that event information is stored and available on the UE (Step 504). Upon receiving the event information indicator, the radio access network decides if the event information is desired. If the radio access network desires the event information stored on the UE, the radio access network sends a request indicator to the UE requesting that the event information be communicated to a requesting device (Step 505). In one example, the requesting device is a radio access control node. Similar to the event information indicator, the request indicator may be a sequence of bits added to an unrelated message that is to be sent from the radio access network to the UE. In another example, the request indicator is sent in a dedicated message from the radio access network to UE. In Step 506, the UE determines if the presently registered PLMN identification is included in the list of PLMN identifications stored with the even information. If the presently registered PLMN identification is included in the list of PLMN identifications, then the UE transmits the event information to the requesting device (Step 507). In the event that the registered PLMN identification is not included in the stored list of PLMN identifications, then the UE does not communicate the event information to any device.

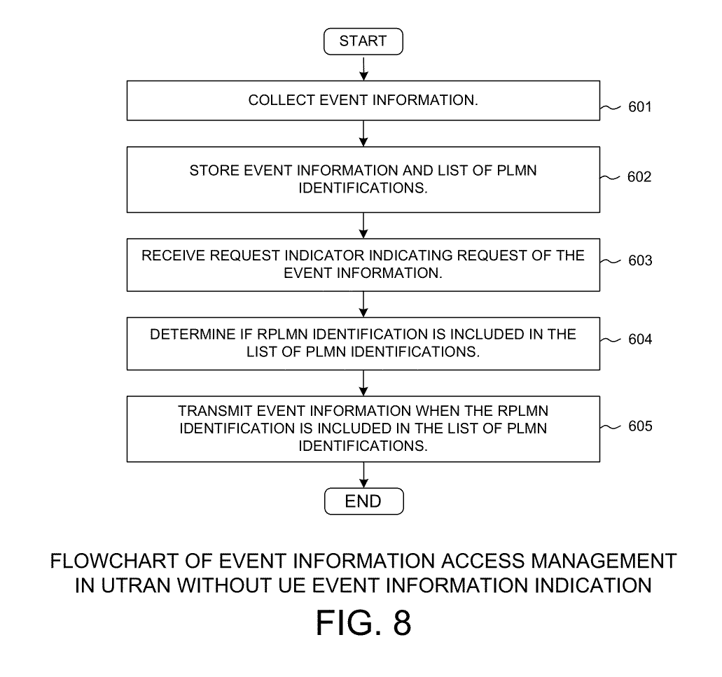

FIG. 8 is a flow chart of a method of management of event information access without UE event information notification in accordance with one novel aspect. The mobile network comprises a UE and a radio access network (RAN). In step 601, the UE begins measuring and collecting event information observed by the UE during operation. Upon acquiring event information, the UE then stores the collected event information and an existing list of PLMN identifications previously stored in the UE (Step 602). In one example, the stored list of PLMN identifications is either a list of equivalent PLMN (EPLMN) identifications or a list of equivalent home PLMN (EHPLMN) identifications. In another example, the UE has a PLMN type indicator value stored in memory that is used by the UE to determine whether the list of PLMN identifications stored with the collected event information is a list of EHPLMN identifications or a list of EPLMN identifications. In another example, the list of PLMN identifications stored with the event information is a list of Equivalent Home Public Land Mobile Networks (EHPLMN) identifications when the UE is not roaming.

In Step 603, the radio access network sends a request indicator to the UE requesting that the event information be communicated to a requesting device. At this point in time, the radio access network has not received an event information indicator from the UE, but rather the radio access network is polling the UE on the chance that the UE does have stored event information. In one example, the requesting device is a radio access control node. The request indicator may be a sequence of bits added to an unrelated message that is to be sent from the radio access network to the UE. In another example, the request indicator is sent in a dedicated message from the radio access network to UE. In Step 604, the UE determines if the presently registered PLMN identification is included in the list of PLMN identifications stored with the even information. If the presently registered PLMN identification is included in the list of PLMN identifications, then the UE transmits the event information to the requesting device (Step 605). In the event that the registered PLMN identification is not included in the stored list of PLMN identifications, then the UE does not communicate the event information to any device.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
determining if a first presently registered Public Land Mobile Network (PLMN) identification is included in a reference list of PLMN identifications; and
transmitting event information observed by an user equipment (UE) when the presently registered PLMN identification is included in the reference list of PLMN identifications, wherein the reference list of PLMN identifications includes either PLMN identifications copied from a list of Equivalent PLMN (EPLMN) identifications or PLMN identifications copied from a list of Equivalent Home PLMN (EHPLMN) identifications.

2. The method of claim 1, further comprising:
collecting event information; and
storing the event information and the reference list of PLMN identifications in a storage device within the UE.

3. The method of claim 2, further comprising:
sending an event information indicator that indicates that event information is available when the first presently registered PLMN identification is included in the reference list of PLMN identifications.

4. The method of claim 3, further comprising:
receiving a request indicator indicating a request that the event information be communicated to a requesting device;
determining a second presently registered PLMN identification; and
determining if the second presently registered PLMN identification is included in the reference list of PLMN identifications.

5. The method of claim 1, wherein the event information includes logs of Minimization Drive Test (MDT) measurement information, logs of broadcast communication failure information, logs of multicast communication failure information, logs of Random Access Channel (RACH) performance, and logs of communication problems including Radio Link Failure, Handover Failure, and Radio Resource Control (RRC) Connection Establishment Failure.

6. The method of claim 1, wherein the event information includes UE velocity information.

7. The method of claim 1, further comprising not transmitting the event information indicator when the first presently registered PLMN identification is not included in the reference list of PLMN identifications.

8. The method of claim 4, further comprising not transmitting the event information to the requesting device when the second presently registered PLMN identification is not included in the reference list of PLMN identifications.

9. The method of claim 1, wherein a PLMN type indicator value determines the type of PLMN identifications included in the first list of PLMN identifications, and wherein the PLMN identifications included in the first list of PLMN identifications are Equivalent Home Public Land Mobile Networks (EHPLMN) identifications when the PLMN type indicator is set to a first value.

10. The method of claim 1, wherein the PLMN identifications included in the reference list of PLMN identifications are Equivalent Home Public Land Mobile Networks (EHPLMN) identifications when the UE is not roaming.

11. The method of claim 4, wherein the sending of the event information, the receiving of the request indicator, and the transmitting of the event information are performed across a Radio Access Network (RAN), and wherein the RAN is a Universal Mobile Telecommunications System (UMTS), an Evolved UMTS Terrestrial Radio Access Network (EUTRA), a High Speed Downlink Packet Access (HSDPA), a High Speed Uplink Packet Access (HSUPA), a Code Division Multiple Access (CDMA), Self Organizing Network (SON), or an Orthogonal Frequency Division Multiple Access (OFDMA) radio access network.

12. The method of claim 1, wherein the determining and transmitting are performed by the UE.

13. A method, comprising:
initiating a communication link with a User Equipment (UE), wherein a presently registered Public Land Mobile Network (PLMN) identification is stored in the UE;
receiving an event information indicator from the UE indicating that event information is available;
sending a request indicator to the UE indicating a request that the event information be communicated to a requesting device; and
receiving the event information from the UE when the presently registered PLMN identification is included in a reference list of PLMN identifications stored in the UE.

14. The method of claim 13, wherein the event information includes logs of Minimization Drive Test (MDT) measurement information, logs of broadcast communication failure information, logs of multicast communication failure information, logs of Random Access Channel (RACH) performance, and logs of communication problems including Radio Link Failure, Handover Failure, and Radio Resource Control (RRC) Connection Establishment Failure.

15. The method of claim 13, wherein the sending of (c) and the receiving of (b) and (d) are performed by a Radio Access Network (RAN), and wherein the RAN is a Universal Mobile Telecommunications System (UMTS), an Evolved UMTS Terrestrial Radio Access Network (EUTRA), a High Speed Downlink Packet Access (HSDPA), a High Speed Uplink Packet Access (HSUPA), a Code Division Multiple Access (CDMA), a Self Organizing Network (SON), or an Orthogonal Frequency Division Multiple Access (OFDMA) radio access network.

16. A User Equipment (UE), comprising:
a storage device that stores a first list of Public Land Mobile Network (PLMN) identifications, wherein the first list of PLMN identifications is either a list of Equivalent PLMN (EPLMN) identifications or a list of Equivalent Home PLMN (EHPLMN) identifications;
a processor that causes a second list of PLMN identifications to be stored in the storage device, wherein the second list of PLMN identities is a copy of the first list of PLMN identities;
an event measurement module that collects event information, wherein the event information and a presently registered PLMN identification are stored in the storage device; and
a radio that communicates event information across a Radio Access Network (RAN) to a RAN control node when the presently registered PLMN identification is included in the second list of PLMN identifications.

17. The UE of claim 16, wherein the radio of the UE transmits an event information indicator indicating that event information is available.

18. The UE of claim 16, wherein the radio of the UE receives a request indicator indicating a request that the event information be communicated to a requesting device.

19. The UE of claim 16, wherein the PLMN identifications included in the second list of PLMN identifications are Equivalent Public Land Mobile Networks (EPLMN) or Equivalent Home Public Land Mobile Networks (EHPLMN).

20. The UE of claim 16, wherein the RAN is a Universal Mobile Telecommunications System (UMTS), an Evolved UMTS Terrestrial Radio Access Network (EUTRA), a High Speed Downlink Packet Access (HSDPA), a High Speed Uplink Packet Access (HSUPA), a Code Division Multiple Access (CDMA), Self Organizing Network (SON), or an Orthogonal Frequency Division Multiple Access (OFDMA) radio access network.
